(19) United States
(12) Patent Application Publication
(10) Pub. No.: US 2026/0075371 A1
(43) Pub. Date: Mar. 12, 2026

(54) SUPPORTING MULTIPLE CONVERSATIONS USING HEARABLE-TO-HEARABLE COMMUNICATION

(71) Applicant: Sony Group Corporation, Tokyo (JP)

(72) Inventors: James R. Milne, Ramona, CA (US); Justin Kenefick, San Diego, CA (US); William Clay, San Diego, CA (US)

(73) Assignee: Sony Group Corporation, Tokyo (JP)

(21) Appl. No.: 18/883,794

(22) Filed: Sep. 12, 2024

(51) Int. Cl. H04R 25/00; G06F 3/01

(52) U.S. Cl. CPC H04R 25/554; G06F 3/017

(57) ABSTRACT

Implementations generally relate to conversations using hearable-to-hearable communication, according to some implementations. In some implementations, a method includes establishing a connection between auditory devices of a first group of auditory devices, where the first group of auditory devices includes at least a first auditory device and a second auditory device. The method further includes creating a second group of auditory devices in response to a group creation trigger event. The method further includes establishing a connection between auditory devices of the second group of auditory devices, where the second group of auditory devices includes at least the first auditory device and a third auditory device.

### BACKGROUND

People experience difficulty communicating with each other in noisy environments, even at close range. This issue may be exacerbated when people use hearing aids for communication. Hearing aids have different settings, such as noise cancellation, which may help improve the user's ability to hear, but does not completely fix the problem.

### SUMMARY

Implementations generally relate to conversations using hearable-to-hearable communication. In some implementations, a system includes one or more processors, and includes logic encoded in one or more non-transitory computer-readable storage media for execution by the one or more processors. When executed, the logic is operable to cause the one or more processors to perform operations including: establishing a connection between auditory devices of a first group of auditory devices, where the first group of auditory devices includes at least a first auditory device and a second auditory device; creating a second group of auditory devices in response to a group creation trigger event; and establishing a connection between auditory devices of the second group of auditory devices, where the second group of auditory devices includes at least the first auditory device and a third auditory device.

With further regard to the system, in some implementations, the group creation trigger event is based on a user gesture. In some implementations, the logic when executed is further operable to cause the one or more processors to perform operations including enabling the first auditory device to switch between the first group of auditory devices and the second group of auditory devices. In some implementations, the logic when executed is further operable to cause the one or more processors to perform operations including merging the first group of auditory devices and the second group of auditory devices in response to a group merge trigger event. In some implementations, the logic when executed is further operable to cause the one or more processors to perform operations including closing communication associated with a given group of auditory devices in response to a group close trigger event, where the group close trigger event is based on a user request. In some implementations, the logic when executed is further operable to cause the one or more processors to perform operations including: detecting a fourth auditory device; and connecting the fourth auditory device to at least one of the first group of auditory devices and the second group of auditory devices in response to a join trigger event. In some implementations, the logic when executed is further operable to cause the one or more processors to perform operations including: tracking users of the first auditory device, the second auditory device, and the third auditory device; and modifying communication associated with at least one the first group of auditory devices and the second group of auditory devices based on the tracking of the users.

In some implementations, a non-transitory computer-readable storage medium with program instructions thereon is provided. When executed by one or more processors, the instructions are operable to cause the one or more processors to perform operations including: establishing a connection between auditory devices of a first group of auditory devices, where the first group of auditory devices includes at least a first auditory device and a second auditory device; creating a second group of auditory devices in response to a group creation trigger event; and establishing a connection between auditory devices of the second group of auditory devices, where the second group of auditory devices includes at least the first auditory device and a third auditory device.

With further regard to the computer-readable storage medium, in some implementations, the group creation trigger event is based on a user gesture. In some implementations, the instructions when executed are further operable to cause the one or more processors to perform operations including enabling the first auditory device to switch between the first group of auditory devices and the second group of auditory devices. In some implementations, the instructions when executed are further operable to cause the one or more processors to perform operations including merging the first group of auditory devices and the second group of auditory devices in response to a group merge trigger event. In some implementations, the instructions when executed are further operable to cause the one or more processors to perform operations including closing communication associated with a given group of auditory devices in response to a group close trigger event, where the group close trigger event is based on a user request. In some implementations, the instructions when executed are further operable to cause the one or more processors to perform operations including: detecting a fourth auditory device; and connecting the fourth auditory device to at least one of the first group of auditory devices and the second group of auditory devices in response to a join trigger event. In some implementations, the instructions when executed are further operable to cause the one or more processors to perform operations including: tracking users of the first auditory device, the second auditory device, and the third auditory device; and modifying communication associated with at least one the first group of auditory devices and the second group of auditory devices based on the tracking of the users.

In some implementations, a computer-implemented method includes: establishing a connection between auditory devices of a first group of auditory devices, where the first group of auditory devices includes at least a first auditory device and a second auditory device; creating a second group of auditory devices in response to a group creation trigger event; and establishing a connection between auditory devices of the second group of auditory devices, where the second group of auditory devices includes at least the first auditory device and a third auditory device.

With further regard to the method, in some implementations, the group creation trigger event is based on a user gesture. In some implementations, the method further includes enabling the first auditory device to switch between the first group of auditory devices and the second group of auditory devices. In some implementations, the method further includes merging the first group of auditory devices and the second group of auditory devices in response to a group merge trigger event. In some implementations, the method further includes closing communication associated with a given group of auditory devices in response to a group close trigger event, where the group close trigger event is based on a user request. In some implementations, the method further includes: detecting a fourth auditory device; and connecting the fourth auditory device to at least one of the first group of auditory devices and the second group of auditory devices in response to a join trigger event.

A further understanding of the nature and the advantages of particular implementations disclosed herein may be realized by reference of the remaining portions of the specification and the attached drawings.

### BRIEF DESCRIPTION OF THE DRAWINGS

FIG. 1 is a block diagram of an example network environment for providing group conversations using hearable-to-hearable communication, which may be used for some implementations described herein.

FIG. 2 illustrates example auditory devices, according to some implementations.

FIG. 3 is an example flow diagram for supporting multiple conversations using hearable-to-hearable communication, according to some implementations.

FIG. 4 is a block diagram of an example network environment showing an example use case, according to some implementations.

FIG. 5 is a block diagram of an example network environment showing another example use case, according to some implementations.

FIG. 6 is a block diagram of an example network environment showing other example use cases, according to some implementations.

FIG. 7 is a block diagram of an example network environment showing another example use case, according to some implementations.

FIG. 8 is a block diagram of an example network environment, which may be used for some implementations described herein.

FIG. 9 is a block diagram of an example computer system, which may be used for some implementations described herein.

### DETAILED DESCRIPTION

Implementations generally relate to conversations using hearable-to-hearable communication. Implementations enable, facilitate, and manage multiple conversations using hearable-to-hearable communication. As described in more detail herein, a system supports connecting a given auditory device to multiple groups having multiple conversations concurrently. The system also supports the given auditory device switching between the multiple conversations.

As described in more detail herein, in various implementations, the system establishes a connection between auditory devices of a first group of auditory devices, where the first group of auditory devices includes at least a first auditory device and a second auditory device. The system further creates a second group of auditory devices in response to a group creation trigger event. The system further establishes a connection between auditory devices of the second group of auditory devices, where the second group of auditory devices includes at least the first auditory device and a third auditory device.

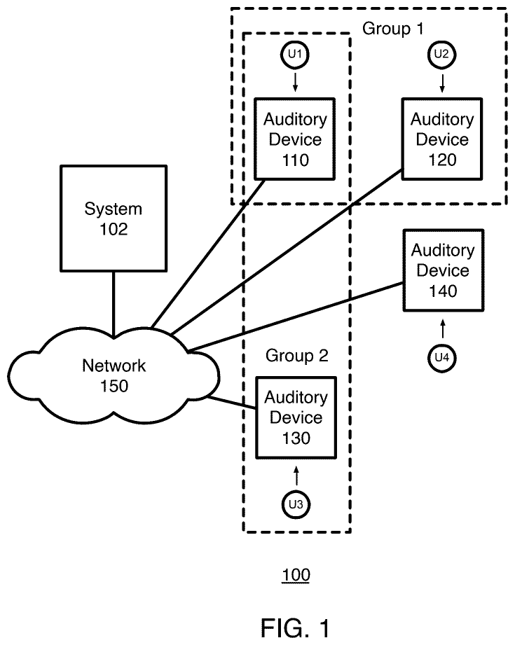

FIG. 1 is a block diagram of an example network environment 100 for providing group conversations using hearable-to-hearable communication, which may be used for some implementations described herein. In some implementations, network environment 100 includes a system 102 and auditory devices 110, 120, 130, and 140, which communication with each other via a network 150. Network 150 may be any suitable communication network such as a Bluetooth network, Bluetooth low energy (LE), a Wi-Fi network, an ultra-wideband network, the Internet, a proprietary network, etc.

In various implementations, environment 100 may be a public or private area where people gather. For example, environment 100 may represent environments such as parks, shopping areas, corporate areas, educational areas, government areas, housing facilities, etc., and the particular environment will depend on the particular implementation.

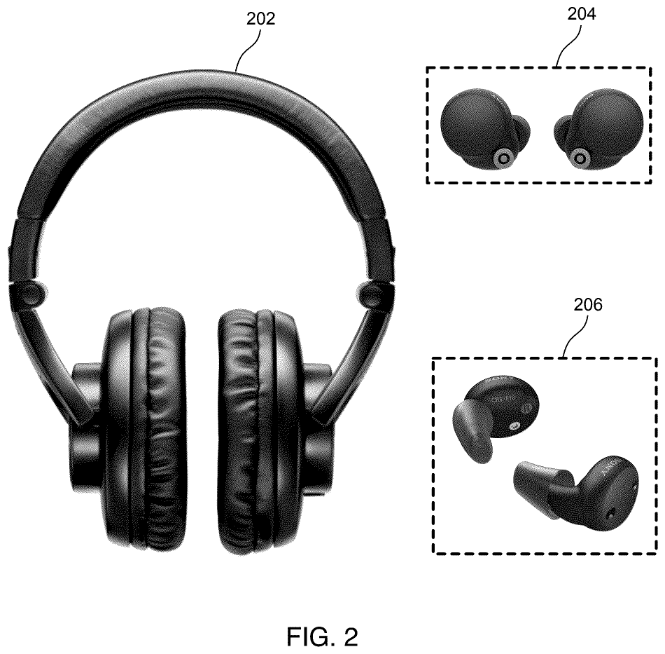

In various implementations, the auditory devices may also be referred to as hearables. Auditory devices or hearables 110, 120, 130, and 140 may include any electronic devices that facilitate a user in hearing conversations. For example, auditory devices 110, 120, 130, and 140 may include hearing aids, headphones, earbuds, etc. Each auditory device 110, 120, 130, and 140 may include a processor, a memory, a speaker, a microphone, and network communication hardware. Each of auditory device 110, 120, 130, and 140 includes a hearing application that forms a connection with other auditory devices. Example implementations directed to auditory devices are described in more detail below, in connection with FIG. 2, for example.

In various implementations, system 102 enables auditory devices 110, 120, 130, and 140 to connect to each other. As described in more detail herein, system 102 may form connections automatically when auditory devices are within range of each other and/or in response to user requests.

In various implementations, system 102 may connect auditory devices in groups. For example, as shown, auditory devices 110 and 120 are in a Group 1, and auditory devices 110 and 130 are in a Group 2, where auditory device 110 is both in Group 1 and in Group 2. In this example scenario, auditory device 140 is not currently in Groups 1 or 2 and may join one of these groups. Example implementations directed to groups of auditory devices, how groups are formed, and how groups are associated with particular auditory devices are described in more detail below.

The hearing application of each auditory device may scan the environment 100 for broadcast identifiers. In various implementations, system 102 may generate a list of broadcast identifiers and organize the broadcast identifiers into different groups. In various embodiments, system 102 may with user consent maintain and stores user information for each user associated with an auditory device and their respective broadcast identifiers created and/or saved by a user 125. In various embodiments, system 102 may utilize artificial intelligence (AI) to automatically recognize users of auditory devices and to form new groups of auditory devices or modify groups based on user behavior such as the auditory device of a user coming into proximity of an existing group of auditory devices, etc. Example implementations directed to the system's use of AI in connection with group conversations using hearable-to-hearable communication are described in more detail herein.

For ease of illustration, FIG. 1 shows one block for system 102 and shows four blocks for auditory devices 110, 120, 130, and 140. Block 102 may represent multiple systems. Also, there may be any number of auditory devices. In other implementations, environment 100 may not have all of the components or elements shown and/or may have other elements including other types of elements instead of, or in addition to, those shown herein.

While system 102 performs implementations described herein, in other implementations, any suitable component or combination of components associated with system 102 or any suitable processor or processors and/or AI associated with system 102 may facilitate performing the implementations described herein.

FIG. 2 illustrates example auditory devices, according to some implementations. Specifically, FIG. 2 illustrates headphones 202, earbuds 204, and a hearing aids 206. In some embodiments, each of the auditory devices 202, 204, and 206 is operable to connect with a different auditory device. Such connections may be made with like types of auditory devices or different types of devices. The auditory devices may be manufactured by Sony or other companies. For ease of illustration, each auditory device referred to herein such as auditory devices 110, 120, 130, and 140, etc. of FIG. 1 may represent a pair of hearables for the left and right ears of a user.

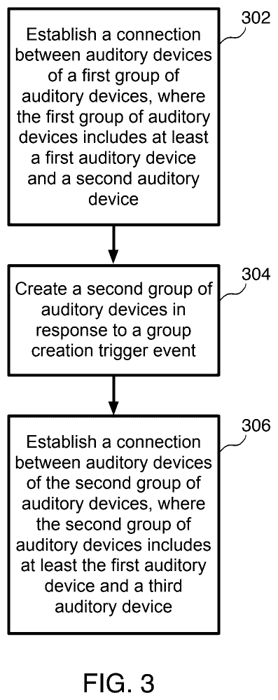

FIG. 3 is an example flow diagram for supporting multiple conversations using hearable-to-hearable communication, according to some implementations. Referring to both FIGS. 1 and 3, a method is initiated at block 302, where a system such as system 102 establishes a connection between auditory devices of a first group of auditory devices in real time. In various embodiments, the first group of auditory devices includes at least a first auditory device and a second auditory device, such as auditory devices 110 and 120 of Group 1 of FIG. 1.

While system 102 supports creation of a connection or communication link for unicast communication (e.g., 1-to-1 communication) and/or a broadcast communication (e.g., 1-to-many or many-to-many communication) in real time, system 102 also supports multiple connections or communication links among multiple auditory devices.

At block 304, system 102 creates a second group of auditory devices in response to a group creation trigger event in real time, such as Group 2 of FIG. 1. In various implementations, the group creation trigger event may be based on a user gesture. The user gesture may vary, depending on the particular implementation. For example, in some implementations, the user gesture may be a nod of the head of the user, the user making eye contact with another user, etc. Further examples of group creation triggers are described in more detail herein.

At block 306, system 102 establishes a connection between auditory devices of the second group of auditory devices in real time. In various implementations, the second group of auditory devices includes at least the first auditory device and a third auditory device, such as auditory devices 110 and 130 of Group 2 of FIG. 1.

In various implementations, system 102 may designate one or more groups of auditory devices as “open,” enabling new auditory devices to seamlessly join. In various implementations, system 102 may designate one or more groups of auditory devices as private. In such private scenarios, system 102 may enable a given user such as a primary user who created a given group of auditory devices to first approve or authorize a new auditory device of a new user to join the given group of auditory devices.

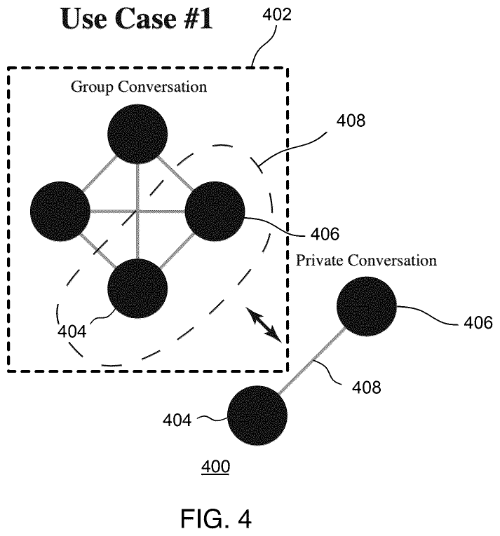

In various implementations, system 102 enables a given auditory device in multiple groups of auditory devices to switch between the groups of auditory devices (e.g., between a first group of auditory devices and a second group of auditory devices). For example, system 102 may enable the user of auditory device 110 to initiate a switch from one communication link (e.g., of Group 1 of auditory devices in FIG. 1) to a different communication link (e.g., of Group 2 of auditory devices in FIG. 1). The user may at will switch back and forth between multiple groups as desired. Further examples of different configurations of groups of auditory devices are described in more detail herein, in FIGS. 4-7, for example.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

FIG. 4 is a block diagram of an example network environment showing an example use case, according to some implementations. In this use case (Use Case #1), the system enables a group to remain intact and remain in the group conversation, and also enables a portion of the group (e.g., some auditory devices) to split off into a new separate second group for a side or private conversation.

For example, shown is a group 402 with 4 auditory devices. In this scenario, the system creates communication link between auditory devices 404 and 406 to create a new group 408. As a result, auditory devices 404 and 406 are in both the group conversation of group 402 and in a private conversation of group 408. The system enables each of auditory devices 404 and 406 to individually switch back and forth between both groups 402 and 408.

In various implementations, the group creation event for creating group 408 may be a user request from either of the users of auditory devices 404 or 406. The user request may be initiated by a predetermined gesture such as a nod, or may be initiated by a voice command (e.g., “Create a private conversation with John.”), or may be initiated via a user interface at a separate device of the one of the users (e.g., smartphone, etc.).

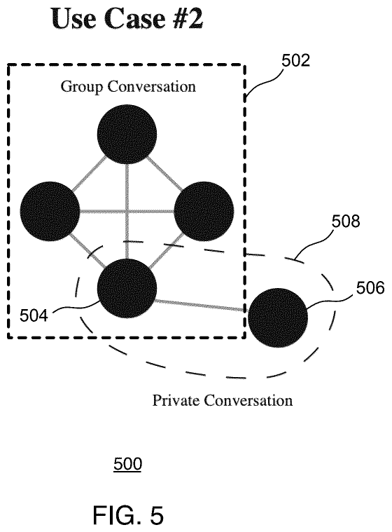

FIG. 5 is a block diagram of an example network environment showing another example use case, according to some implementations. In this use case (Use Case #2), the system enables a group to remain intact and remain the group conversation, and also enables a new separate group to be created for a private conversation.

For example, shown is a group 502 with 4 auditory devices. In various implementations, the system creates a communication link between auditory devices 504 and 506, thereby creating a new second group 508. As a result, auditory device 504 is in both the group conversation of group 502 and in a private conversation with auditory device 506 of group 508. The system enables auditory device 504 to switch back and forth between both groups 502 and 508.

In various implementations, the system may automatically generate the group creation event for creating the group 508 based on AI. For example, in this example scenario, auditory device 506 may be associated with a user who walks up to and becomes in proximity to group 502, including the user associated with auditory device 504. The AI of the system may detect and recognize the user associated with the auditory device 506. The AI may recognize this as a group creation trigger event. As such, if the AI recognizes the user associated with the auditory device 506, the AI of the system may automatically without user intervention create a communication link between auditory devices 504 and 506, and or other auditory devices. Alternatively, the system may prompt either or both users associated with auditory devices 504 and 506, or other users whether to authorize creation of a communication link. In various implementations, the system may determine whether to join auditory device 506 with group 502, or to create a new group such as group 508, as shown in the example of FIG. 5.

In various implementations, the group creation trigger event for creating group 408 may also be a user request from either of the users of auditory devices 504 or 506. The user request may be initiated by a predetermined gesture such as a nod, or may be initiated by a voice command (e.g., “Create a private conversation with Dave.”), or may be initiated at a user interface at a separate device of the one of the users (e.g., smartphone, etc.).

In some implementations, auditory device 506 may be initially unconnected to any other group of auditory devices before joining group 508. In some implementations, auditory device 506 may be already connected to another group of auditory devices. As such, as indicated herein, any given device may be connected to multiple groups of auditory devices.

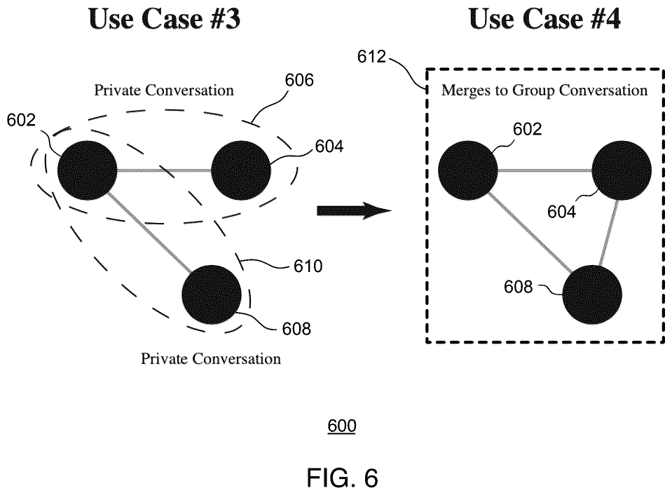

FIG. 6 is a block diagram of an example network environment showing other example use cases, according to some implementations. In one use case (Use Case #3), system 102 enables a given auditory device to be in two separate groups having two separate conversations, respectively. For example, as shown, an auditory device 602 and another auditory device 604 are in a group 606. Auditor device 602 and another auditory device 608 are in a separate second group 610. In this example implementation, groups 606 and 610 involve private conversations.

In another use case (Use Case #4), system 102 merges a first group of auditory devices such as group 606 and the second group of auditory devices such as group 608 in response to a group merge trigger event. For example, as shown, auditory device 602, auditory device 606, and auditory device 608 are merged into a single group 612 involving a group conversation. Here, the system creates a new link between auditory devices 604 and 606 such that all three devices are linked.

In this use scenario, the system may close groups 606 and 610, including their respective private conversations, after creating group 612. In some implementations, the system may also create group 612 and keep groups 606 and 610 intact allow the private conversation to continue, which would be similar to Use Case #1 of FIG. 4.

In some implementations, either or both of groups 606 and 610 may be larger groups of two or more auditory devices in one or two group conversations. In any case, the system may merge the two groups regardless of their sizes into a single group having a single group conversation.

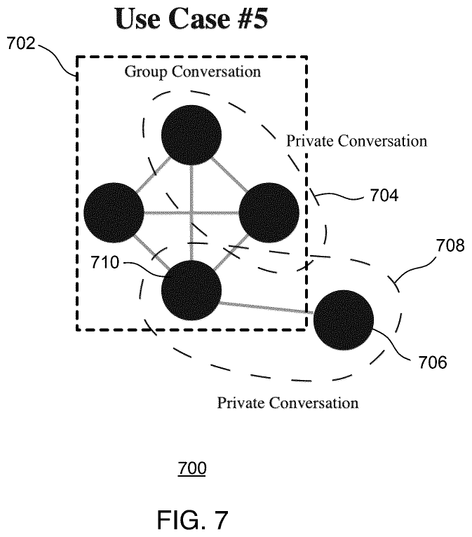

FIG. 7 is a block diagram of an example network environment showing another example use case, according to some implementations. In this use case (Use Case #5), the system enables a group 702 to remain intact and remain in the group conversation, and creates a separate second group 704 between existing auditory devices of group 702, where the new group 704 is in a private conversation.

In this example use case, system 102 detects a new auditory device such as auditory device 706 in proximity to group 702, which the system may recognize as group creation trigger event and/or a join trigger event. The system then connects or joins auditory device 706 to an existing first group of auditory devices such as group 702 and/or to an existing second group of auditory devices such as group 704 and/or creates a newly created third group of auditory devices such as group 708. In this example implementation, the system creates group 708, which contains both auditory device 706 and an existing auditory device such as auditory device 710 in response to a join trigger event. Here, the system creates group 708 with a communication link between auditory device 706 and auditory device 710 to form a private conversation between the two auditory devices.

In some implementations, auditory device 706 may be initially unconnected to any other group of auditory devices. In some implementations, the auditory device 706 may be already connected to another group of auditory devices. As such, as indicated herein, any given device may be connected to multiple groups of auditory devices. The system enables auditory device 710 to switch back and forth between both groups 702 and 708.

In various implementations, the system may automatically generate the group creation trigger event for creating the group 708 based on AI. For example, as auditory device 706 becomes in proximity to group 702, the AI of the system may prompt any one or more of the devices shown whether to join auditory device 706 to an existing group or to a newly created group.

In various implementations, the group creation trigger event for creating group 708 may also be a user request from any of the users of the auditory devices shown. The user request may be initiated by a predetermined gesture such as a nod, or may be initiated by a voice command (e.g., “Create a private conversation with Bob.”), or may be initiated at a user interface at a separate device of the one of the users (e.g., smartphone, etc.).

In various implementations, system 102 closes communication associated with a given group of auditory devices in response to a group close trigger event, where the group close trigger event is based on a user request. In various implementations, the group close trigger event may also be based on at least one auditory device leaving the given group of auditory devices. For example, if a given user turns around and walks away, the system may determine that the user has left the group and recognize the behavior as a group close trigger event. The system may automatically close the communication link associated with that user. In some embodiments, the system may deem that a given user has left the group if the system does not hear anything from that user or if that user is not visible or otherwise detectable after a predetermined amount of time (e.g., 1 minute, 2 minutes, etc.).

In some scenarios, if one or more auditory devices leave the given group of auditory devices, there may be only the one auditory device remaining in the given group of auditory devices. In various implementations, if only one auditory device remains in a given group of auditory devices, the system may leave the communication link open for a predetermined time period (e.g., 30 seconds, 1 minute, 2 minutes, etc.) before closing the respective communication link associated with the group in order to give the user an opportunity to join the auditory device of another user to the group.

In various implementations, system 102 tracks users of the various auditory devices that are detectable. The system may modify communication associated with any one or more groups of auditory devices based on the tracking of the users. The modification of the communication may involve the creation of a new group of auditory devices, creating or removing a communication link between one or more auditory devices and an existing group of auditory devices to which the one or more auditory devices belongs. Examples of such modifications are described above in connection with FIGS. 4-7, for example.

In various implementations, system 102 may track users using various types of devices. Such devices may include eye-tracking cameras and front facing cameras. For example, when a given user or subject moves system 102 may utilize a given camera to track the proximity and position of user, as well track the location of the user (e.g., 30 degrees to the left, 45 degrees to the right, etc.). In various implementations, system 102 may also track head movements of user (e.g., leaning over, etc.). The AI may be trained to determine whether a given user intends to join a given group. For example, a nod or head tilt toward another user may indicate to the AI that the user wants to engage the other user in a private or group conversation in accordance to any of the scenarios described herein.

In various implementations, system 102 may utilize AI to perform facial recognition on users in front of a live camera. In various implementations, system 102 may also utilize any suitable voice recognition technologies for recognizing voices of users. System 102 may access a library database for saving and/or looking up faces, voices, names, hearable identification (ID)/addresses. In various implementations, system 102 may also utilize bone conduction technologies for enhancing verbal communication.

In various embodiments, system 102 may enable a user to switch between communication links using predetermined head gestures based on movement and/or facial recognition. System 102 may enable a user to switch between communication links using eye tracking and/or blinking. For example, if a give user makes eye contact with another user, system 102 may automatically establish a communication link or prompt one or more of the users to authorize a communication link between their respective auditory devices.

System 102 may enable a user to switch between communication links using verbal cues. The system may enable a user to switch between communication links using a user interface of a smart device. The AI of the system may enable a user to switch between communication links using any combination and/or permutations of techniques. In various implementations, the system may utilize AI detect and recognize a user of an auditory device when the user walks up to another user. The AI may automatically recognize the user using facial recognition and then establish a communication link between their respective auditory devices. In various implementations, the system may automatically join a new auditory device to an existing group and/or to a new group. Alternatively, the system may prompt one or both users associated with the auditory devices in proximity to indicate whether the new auditory device shall be connected to an existing group or to a newly created group. Once one or more connections are established, the system may enable and/or facilitate switching of the auditory devices between groups.

In various implementations, system 102 may create, merge, close communication links and/or enable a user to switch between the communication links using a user interface (UI) or graphical UI (GUI) via smart glasses and/or a smart device.

In various implementations, system 102 may utilize AI to keep track of open communication links, keep track of how many communication links are open, and keep track of who is present in each communication link/group of auditory devices. System 102 may also utilize AI to monitor when a background group of auditory devices is trying to get a given user's attention and may enable the given user to switch to the background group of auditory devices.

Implementations described herein provide various benefits. For example, implementations enable groups of auditory devices to be created or closed automatically in real time without user intervention and/or with minimal user interaction intuitively and conveniently with minimal effort. Implementations described herein also enable auditory devices of user to join, switch to or from a given conversation (e.g., connected group of auditory devices) in real time without users relying on a smart phone.

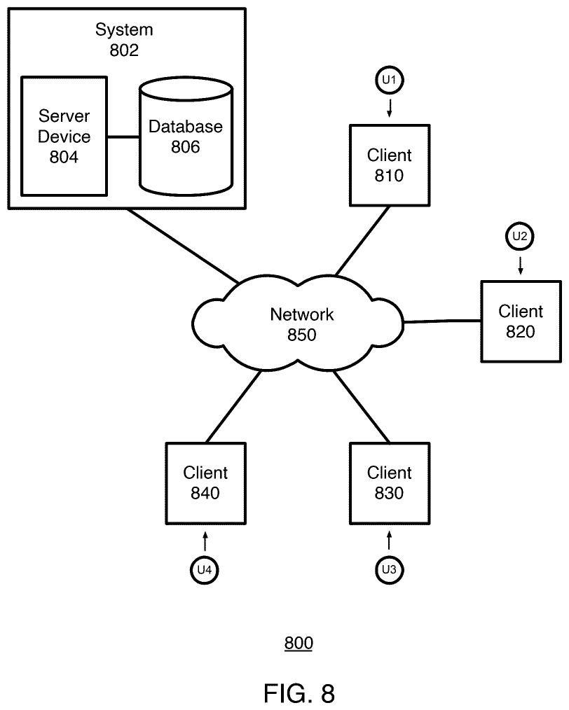

FIG. 8 is a block diagram of an example network environment 800, which may be used for some implementations described herein. In some implementations, network environment 800 includes a system 802, which includes a server device 804 and a database 806. For example, system 802 may be used to implement system 102 of FIG. 1, as well as to perform implementations described herein. Network environment 800 also includes client devices 810, 820, 830, and 840, which may communicate with system 802 and/or may communicate with each other directly or via system 802. Network environment 800 also includes a network 850 through which system 802 and client devices 810, 820, 830, and 840 communicate. Network 850 may be any suitable communication network such as a Wi-Fi network, Bluetooth network, the Internet, etc.

For ease of illustration, FIG. 8 shows one block for each of system 802, server device 804, and network database 806, and shows four blocks for client devices 810, 820, 830, and 840. Blocks 802, 804, and 806 may represent multiple systems, server devices, and network databases. Also, there may be any number of client devices. In other implementations, environment 800 may not have all of the components shown and/or may have other elements including other types of elements instead of, or in addition to, those shown herein.

While server device 804 of system 802 performs implementations described herein, in other implementations, any suitable component or combination of components associated with system 802 or any suitable processor or processors associated with system 802 may facilitate performing the implementations described herein.

In the various implementations described herein, a processor of system 802 and/or a processor of any client device 810, 820, 830, and 840 cause the elements described herein (e.g., information, etc.) to be displayed in a user interface on one or more display screens.

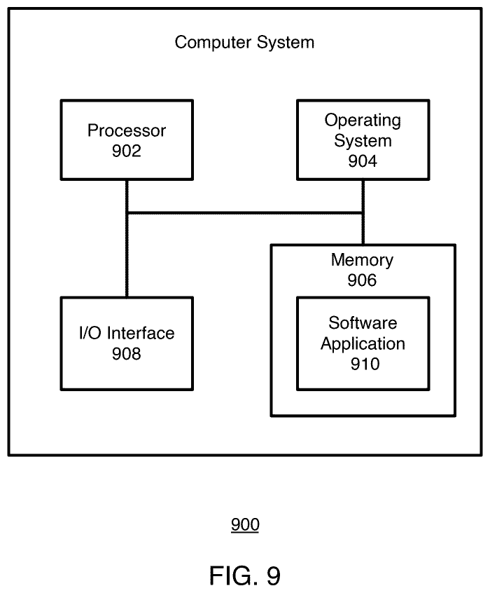

FIG. 9 is a block diagram of an example computer system 900, which may be used for some implementations described herein. For example, computer system 900 may be used to implement server device 804 of FIG. 8 and/or system 102 of FIG. 1, as well as to perform implementations described herein. In some implementations, computer system 900 may include a processor 902, an operating system 904, a memory 906, and an input/output (I/O) interface 908. In various implementations, processor 902 may be used to implement various functions and features described herein, as well as to perform the method implementations described herein. While processor 902 is described as performing implementations described herein, any suitable component or combination of components of computer system 900 or any suitable processor or processors associated with computer system 900 or any suitable system may perform the steps described. Implementations described herein may be carried out on a user device, on a server, or a combination of both.

Computer system 900 also includes a software application 910, which may be stored on memory 906 or on any other suitable storage location or computer-readable medium. Software application 910 provides instructions that enable processor 902 to perform the implementations described herein and other functions. Software application may also include an engine such as a network engine for performing various functions associated with one or more networks and network communications. The components of computer system 900 may be implemented by one or more processors or any combination of hardware devices, as well as any combination of hardware, software, firmware, etc.

For ease of illustration, FIG. 9 shows one block for each of processor 902, operating system 904, memory 906, I/O interface 908, and software application 910. These blocks 902, 904, 906, 908, and 910 may represent multiple processors, operating systems, memories, I/O interfaces, and software applications. In various implementations, computer system 900 may not have all of the components shown and/or may have other elements including other types of components instead of, or in addition to, those shown herein.

Although the description has been described with respect to particular implementations thereof, these particular implementations are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular implementations including C, C++, C#, Java, JavaScript, assembly language, etc. Different programming techniques can be employed such as procedural or object oriented. The routines can execute on a single processing device or multiple processors. Although the steps, operations, or computations may be presented in a specific order, this order may be changed in different particular implementations. In some particular implementations, multiple steps shown as sequential in this specification can be performed at the same time.

Particular implementations may be implemented in a non-transitory computer-readable storage medium (also referred to as a machine-readable storage medium) for use by or in connection with the instruction execution system, apparatus, or device. Particular implementations can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,”“offline,”in a “batch mode,”etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the”includes plural references unless the context clearly dictates otherwise. Also, as used in the description herein and throughout the claims that follow, the meaning of “in”includes “in”and “on”unless the context clearly dictates otherwise.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit.

What is claimed is:

1. A system comprising:
one or more processors; and
logic encoded in one or more non-transitory computer-readable storage media for execution by the one or more processors and when executed operable to cause the one or more processors to perform operations comprising:
establishing a connection between auditory devices of a first group of auditory devices, wherein the first group of auditory devices comprises at least a first auditory device and a second auditory device;
creating a second group of auditory devices in response to a group creation trigger event; and
establishing a connection between auditory devices of the second group of auditory devices, wherein the second group of auditory devices comprises at least the first auditory device and a third auditory device.

2. The system of claim 1, wherein the group creation trigger event is based on a user gesture.

3. The system of claim 1, wherein the logic when executed is further operable to cause the one or more processors to perform operations comprising enabling the first auditory device to switch between the first group of auditory devices and the second group of auditory devices.

4. The system of claim 1, wherein the logic when executed is further operable to cause the one or more processors to perform operations comprising merging the first group of auditory devices and the second group of auditory devices in response to a group merge trigger event.

5. The system of claim 1, wherein the logic when executed is further operable to cause the one or more processors to perform operations comprising closing communication associated with a given group of auditory devices in response to a group close trigger event, wherein the group close trigger event is based on a user request.

6. The system of claim 1, wherein the logic when executed is further operable to cause the one or more processors to perform operations comprising:
detecting a fourth auditory device; and
connecting the fourth auditory device to at least one of the first group of auditory devices and the second group of auditory devices in response to a join trigger event.

7. The system of claim 1, wherein the logic when executed is further operable to cause the one or more processors to perform operations comprising:
tracking users of the first auditory device, the second auditory device, and the third auditory device; and
modifying communication associated with at least one the first group of auditory devices and the second group of auditory devices based on the tracking of the users.

8. A non-transitory computer-readable storage medium with program instructions stored thereon, the program instructions when executed by one or more processors are operable to cause the one or more processors to perform operations comprising:
establishing a connection between auditory devices of a first group of auditory devices, wherein the first group of auditory devices comprises at least a first auditory device and a second auditory device;
creating a second group of auditory devices in response to a group creation trigger event; and
establishing a connection between auditory devices of the second group of auditory devices, wherein the second group of auditory devices comprises at least the first auditory device and a third auditory device.

9. The computer-readable storage medium of claim 8, wherein the group creation trigger event is based on a user gesture.

10. The computer-readable storage medium of claim 8, wherein the instructions when executed are further operable to cause the one or more processors to perform operations comprising enabling the first auditory device to switch between the first group of auditory devices and the second group of auditory devices.

11. The computer-readable storage medium of claim 8, wherein the instructions when executed are further operable to cause the one or more processors to perform operations comprising merging the first group of auditory devices and the second group of auditory devices in response to a group merge trigger event.

12. The computer-readable storage medium of claim 8, wherein the instructions when executed are further operable to cause the one or more processors to perform operations comprising closing communication associated with a given group of auditory devices in response to a group close trigger event, wherein the group close trigger event is based on a user request.

13. The computer-readable storage medium of claim 8, wherein the instructions when executed are further operable to cause the one or more processors to perform operations comprising:
detecting a fourth auditory device; and
connecting the fourth auditory device to at least one of the first group of auditory devices and the second group of auditory devices in response to a join trigger event.

14. The computer-readable storage medium of claim 8, wherein the instructions when executed are further operable to cause the one or more processors to perform operations comprising:
tracking users of the first auditory device, the second auditory device, and the third auditory device; and
modifying communication associated with at least one the first group of auditory devices and the second group of auditory devices based on the tracking of the users.

15. A computer-implemented method comprising:
establishing a connection between auditory devices of a first group of auditory devices, wherein the first group of auditory devices comprises at least a first auditory device and a second auditory device;
creating a second group of auditory devices in response to a group creation trigger event; and
establishing a connection between auditory devices of the second group of auditory devices, wherein the second group of auditory devices comprises at least the first auditory device and a third auditory device.

16. The method of claim 15, wherein the group creation trigger event is based on a user gesture.

17. The method of claim 15, further comprising enabling the first auditory device to switch between the first group of auditory devices and the second group of auditory devices.

18. The method of claim 15, further comprising merging the first group of auditory devices and the second group of auditory devices in response to a group merge trigger event.

19. The method of claim 15, further comprising closing communication associated with a given group of auditory devices in response to a group close trigger event, wherein the group close trigger event is based on a user request.

20. The method of claim 15, further comprising:
detecting a fourth auditory device; and
connecting the fourth auditory device to at least one of the first group of auditory devices and the second group of auditory devices in response to a join trigger event.
